(19) United States
(12) Patent Application Publication
(10) Pub. No.: US 2025/0178876 A1
(43) Pub. Date: Jun. 5, 2025

(54) MULTIDIRECTIONAL DRIVING INDUSTRIAL HANDLING VEHICLE

(71) Applicant: BANYITONG SCIENCE AND TECHNOLOGY DEVELOPING CO., LTD., Hefei (CN)

(72) Inventors: Bing SHEN, Hefei (CN); Li WANG, Hefei (CN); Tingting DOU, Hefei (CN)

(73) Assignee: BANYITONG SCIENCE AND TECHNOLOGY DEVELOPING CO., LTD., Hefei (CN)

(21) Appl. No.: 18/724,613

(22) PCT Filed: Aug. 7, 2023
(86) PCT No.: PCT/CN2023/111476

§ 371 Date: Jun. 27, 2024

(30) Foreign Application Priority Data
Jun. 20, 2023 (CN) 202310732232.5

(51) Int. Cl. B66F 9/075

(52) U.S. Cl. CPC B66F 9/07572; B66F 9/07568

(57) ABSTRACT

A multidirectional driving industrial handling vehicle includes a vehicle frame. Two load-bearing wheels with a steering function are symmetrically arranged on a side of the vehicle frame adjacent to a front, and a drive wheel with driving and steering functions is arranged on a side of the vehicle frame adjacent to a rear. Specifically, the load-bearing wheel is rotatably arranged on a first rotary support member through a pin and a wheel frame, and the first rotary support member is rotatably arranged on the vehicle frame. The vehicle frame is provided with a first steering motor configured to drive the load-bearing wheel to rotate. By connecting each wheel of the forklift with the steering device, each wheel has independent steering function, so that the whole vehicle has a variety of driving modes such as straight driving, lateral driving, oblique driving, in-situ rotation, etc., and realizes multidirectional driving.

### CROSS REFERENCE TO THE RELATED APPLICATIONS

This application is the national phase entry of International Application No. PCT/CN2023/111476, filed on Aug. 7, 2023, which is based upon and claims priority to Chinese Patent Application No. 202310732232.5, filed on Jun. 20, 2023, the entire contents of which are incorporated herein by reference.

### TECHNICAL FIELD

The present invention relates to the technical field of forklift equipment, and more particularly, to a multidirectional driving industrial handling vehicle.

### BACKGROUND

Chinese Patent with publication No. CN214456564U discloses a forklift automatic guided vehicle (AGV) with a stand-alone path optimization function, including an AGV body, a lifting mast, and a truck. An industrial control all-in-one machine located above the AGV body is mounted on the lifting mast and is retractable. A control system and a wireless communication unit connected to the control system are arranged inside the AGV body. The control system is connected to the industrial control all-in-one machine configured to display or modify a running path of the forklift AGV. However, in the process of practical use, there are still the following disadvantages: the above forklift adopts the traditional chassis device, that is, steering is realized through the rear wheel, resulting in a large turning radius and a poor flexibility, which is not suitable for the dense storage layout and the fast transfer and stacking of cargo.

### SUMMARY

An objective of the present invention is to provide a multidirectional driving industrial handling vehicle to solve the problems raised in the background technology.

In order to achieve the above objective, the present invention provides the following technical solution:

A multidirectional driving industrial handling vehicle includes a vehicle frame. Two load-bearing wheels with a steering function are symmetrically arranged on a side of the vehicle frame adjacent to a front, and a drive wheel with driving and steering functions is arranged on a side of the vehicle frame adjacent to a rear.

Specifically, the load-bearing wheel is rotatably arranged on a first rotary support member through a pin and a wheel frame, and the first rotary support member is rotatably arranged on the vehicle frame. The vehicle frame is provided with a first steering motor configured to drive the load-bearing wheel to rotate, and a main shaft of the first steering motor is connected to an input end of a first reduction gearbox. The first reduction gearbox is mounted on the vehicle frame through a mounting plate, and an output end of the first reduction gearbox is provided with a tapered pinion. The tapered pinion is engaged with a tapered rack wheel on the first rotary support member, and the tapered rack wheel is integrated with an outer ring of the first rotary support member.

The drive wheel is arranged on an output end of a second reduction gearbox, and an input end of the second reduction gearbox is provided with a drive motor for driving the drive wheel to rotate. The second reduction gearbox is connected to a second rotary support member, and the second rotary support member is rotatably arranged on a fixed plate on the vehicle frame. The fixed plate is provided with a second steering motor configured to drive the drive wheel to rotate, a main shaft of the second steering motor is provided with a steering pinion, and the steering pinion is engaged with a steering rack wheel on the second rotary support member.

Preferably, one drive wheel is arranged on a rear axis of the vehicle frame, and forms a three-fulcrum structure with the two load-bearing wheels in the front.

Preferably, two drive wheels are symmetrically arranged about a rear axis of the vehicle frame, and form a four-fulcrum structure with the two load-bearing wheels in the front.

Preferably, the multidirectional driving industrial handling vehicle further includes a mast liftably arranged on the vehicle frame. The mast is connected to a lifting cylinder on the vehicle frame, the lifting cylinder is communicated with a hydraulic assembly on the vehicle frame, and a lower end of the mast is connected to a fork frame.

Preferably, a lithium battery is arranged inside the vehicle frame for supplying power to the whole vehicle.

Compared with the prior art, the advantages of the present invention are as follows:

In the present invention, by connecting each wheel of the forklift with the steering device, each wheel has independent steering function, so that the whole vehicle has a variety of driving modes such as straight driving, lateral driving, oblique driving, in-situ rotation, etc., and realizes multidirectional driving, which can meet the narrow path operation. The vehicle can directly drive away laterally in a straight line after picking up and unloading goods, so as to avoid turning in the roadway, which saves space and is safe and efficient.

### BRIEF DESCRIPTION OF THE DRAWINGS

FIG. 1 is a schematic diagram of the structure of the present invention.

FIG. 2 is a side view of the present invention.

FIG. 3 is a schematic diagram showing the bottom of the vehicle frame of the present invention (three-fulcrum structure).

FIG. 4 is a schematic diagram showing the structure of the drive wheel of the present invention.

FIG. 5 is a schematic diagram showing the bottom of the vehicle frame of the present invention (four-fulcrum structure).

FIG. 6 is a schematic diagram showing a steering structure of the load-bearing wheel of the present invention.

FIG. 7 is a front view showing the steering structure of the load-bearing wheel of the present invention.

In the figures: 1. vehicle frame, 2. load-bearing wheel, 21. pin, 22. wheel frame, 23. first rotary support member, 24. first steering motor, 25. first reduction gearbox, 26. mounting plate, 27. tapered pinion, 28. tapered rack wheel, 3. drive wheel, 31. second reduction gearbox, 32. drive motor, 33. second rotary support member, 34. fixed plate, 35. second steering motor, 36. steering pinion, 37. steering rack wheel, 4. mast, 5. lifting cylinder, 6. fork frame, 7. hydraulic assembly, and 8. lithium battery.

### DETAILED DESCRIPTION OF THE EMBODIMENTS

The technical solution in the embodiments of the present invention will be described clearly and completely below in conjunction with the drawings in the embodiments of the present invention. It is obvious that the described embodiments are only part of the embodiments of the present invention, not all embodiments. Based on the embodiments of the present invention, all other embodiments obtained by those skilled in the art without creative work shall fall within the scope of protection of the present invention.

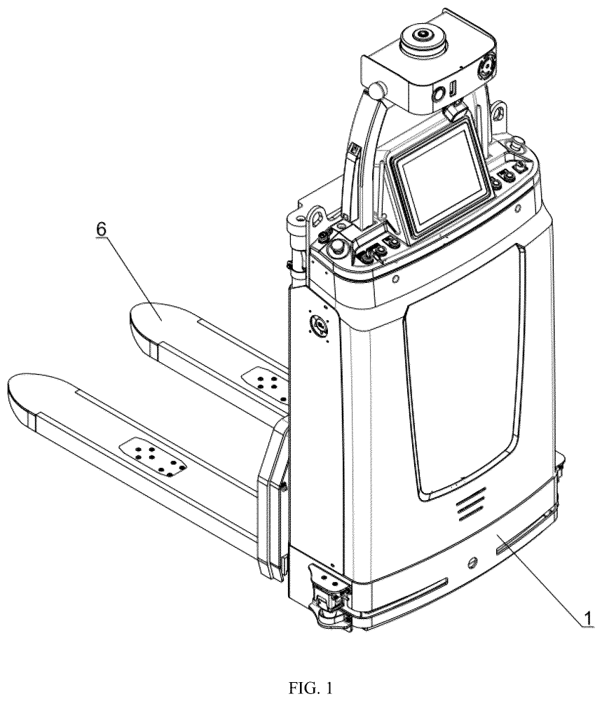

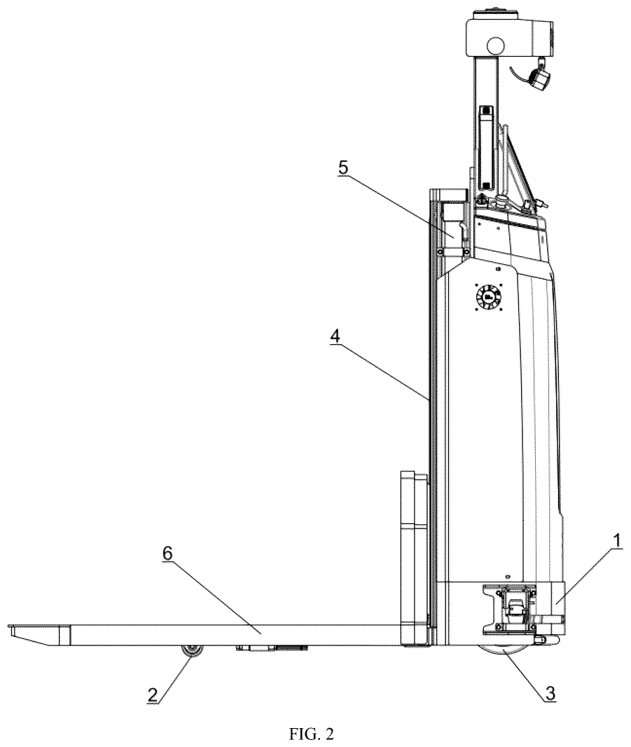

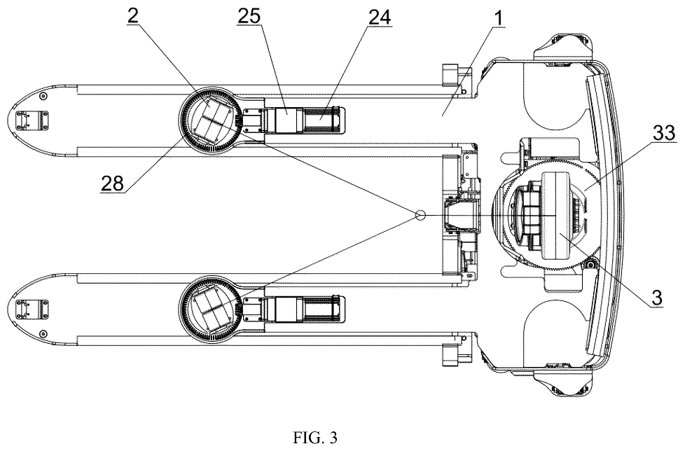

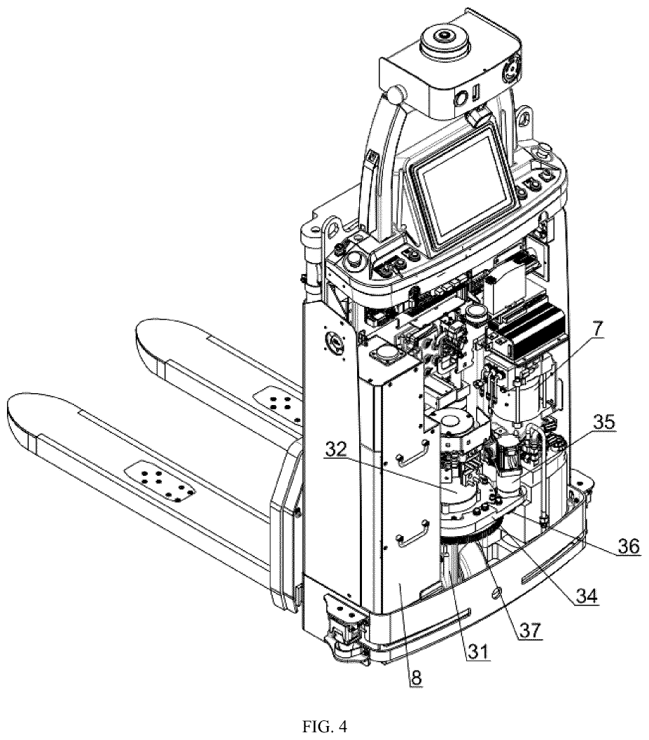

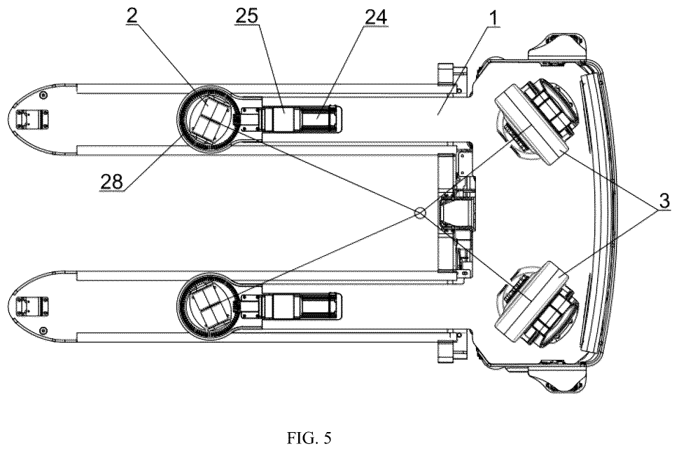

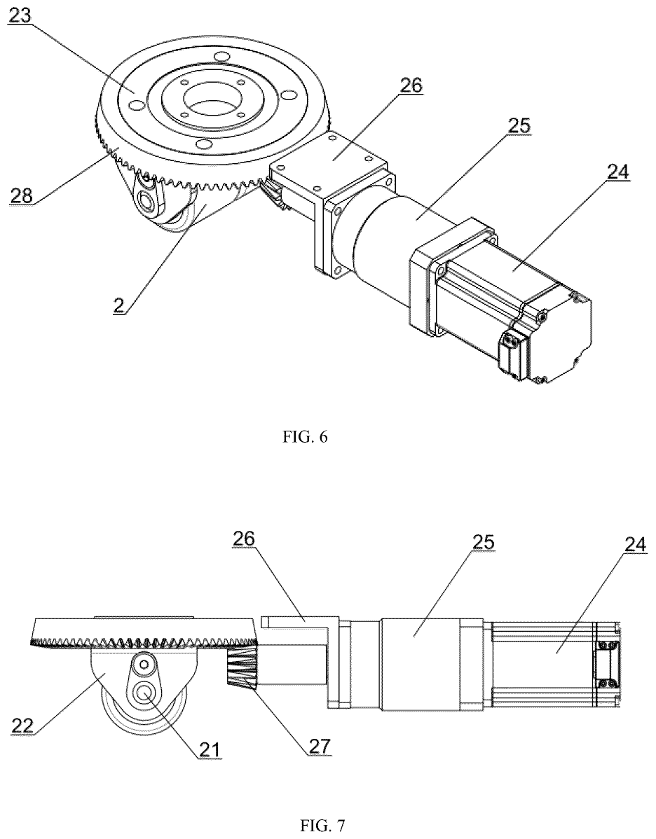

Referring to FIGS. 1-7, the present invention provides a technical solution:

### Embodiment I

A multidirectional driving industrial handling vehicle includes the vehicle frame 1. Two load-bearing wheels 2 with a steering function are symmetrically arranged on a side of the vehicle frame 1 adjacent to the front, and the steering angle of the load-bearing wheel 2 is controllable. In the technical solution of the present embodiment, the vehicle frame 1 is a U-shaped structure including a left support leg and a right support leg, and the two load-bearing wheels 2 are respectively arranged on the left support leg and the right support leg. The load-bearing wheel 2 can steer, but does not have a driving force. The drive wheel 3 with driving and steering functions is arranged on a side of the vehicle frame 1 adjacent to the rear, and the drive wheel 3 provides the driving power for the whole vehicle. In the technical solution of the present embodiment, one drive wheel 3 is arranged on the rear axis of the vehicle frame 1, and forms a three-fulcrum structure with the two load-bearing wheels 2 in the front. The drive wheel 3 is arranged on an output end of the second reduction gearbox 31, and an input end of the second reduction gearbox 31 is provided with the drive motor 32 for driving the drive wheel 3 to rotate. The power outputted by the drive motor 32 is subjected to deceleration and torque-increasement by the second reduction gearbox 31 and then drives the drive wheel 3 to rotate. The second reduction gearbox 31 is connected to the second rotary support member 33. The rotary support member includes an inner ring and an outer ring, and the inner ring and the outer ring are connected by roll balls and a cage. Such structure is similar to the bearing structure. The second rotary support member 33 is rotatably arranged on the fixed plate 34 on the vehicle frame 1, and the fixed plate 34 is provided with the second steering motor 35 configured to drive the drive wheel 3 to rotate. A main shaft of the second steering motor 35 is provided with a steering pinion 36, and the steering pinion 36 is engaged with the steering rack wheel 37 on the second rotary support member 33. Under the action of the steering pinion 36 and the steering rack wheel 37, the second steering motor 35 drives the drive wheel 3 to rotate 360° by taking the axis center of the second rotary support member 33 as the circular center, so that the drive wheel 3 has steering and driving functions finally.

Specifically, the load-bearing wheel 2 is rotatably arranged on the first rotary support member 23 through the pin 21 and the wheel frame 22, and the first rotary support member 23 is rotatably arranged on the vehicle frame 1 (the left support leg and the right support leg). The vehicle frame 1 is provided with the first steering motor 24 configured to drive the load-bearing wheel 2 to rotate, and an absolute encoder is built in the first steering motor 24 and can detect and feed back a steering angle and a wheel position in real time. A main shaft of the first steering motor 24 is connected to an input end of the first reduction gearbox 25, and the first reduction gearbox 25 is mounted on the vehicle frame 1 (the left support leg and the right support leg) through the mounting plate 26. An output end of the first reduction gearbox 25 is provided with a tapered pinion 27, and the tapered pinion 27 is engaged with the tapered rack wheel 28 on the first rotary support member 23, and the tapered rack wheel 28 is integrated with the outer ring of the first rotary support member 23. The first steering motor 24 is subjected to first-stage deceleration through the first reduction gearbox 25, and subjected to second-stage deceleration through the engagement between the tapered pinion 27 and the tapered rack wheel 28. The rotation speed of the load-bearing wheel 2 is accurately controlled by controlling the speed ratio of the first reduction gearbox 25 and the speed ratio of the tapered rack wheel 28 to the tapered pinion 27.

The multidirectional driving industrial handling vehicle further includes the mast 4 liftably arranged on the vehicle frame 1. The mast 4 is connected to the lifting cylinder 5 on the vehicle frame 1, the lifting cylinder 5 is communicated with the hydraulic assembly 7 on the vehicle frame 1. A lower end of the mast 4 is connected to the fork frame 6, and the lithium battery 8 is arranged inside the vehicle frame 1 for supplying power to the whole vehicle.

Moreover, the mounting height and turning radius of the load-bearing wheel 2 of the present invention can meet the use of conventional forks and pallets, that is, the load-bearing wheels 2 in the technical solution of the present embodiment can enter the fork holes of the forks and pallets without non-standard reformed pallets, which can meet the rapid transportation and stacking of conventional goods, thus improving the versatility of the whole device.

### Embodiment II

It is different from the Embodiment I in that: in the technical solution of the present embodiment, two drive wheels 3 are symmetrically arranged about the rear axis of the vehicle frame 1, and form a four-fulcrum structure with the two load-bearing wheels 2 in the front.

Although embodiments of the present invention have been shown and described, for those skilled in the art, it is understandable that a variety of changes, alterations, replacements and modifications may be made to these embodiments without departing from the principle and ideas of the present invention, and the scope of the present invention is limited by the attached claims and their equivalents.

What is claimed is:

1. A multidirectional driving industrial handling vehicle, comprising a vehicle frame, wherein two load-bearing wheels with a steering function are symmetrically arranged on a first side of the vehicle frame and adjacent to a front of the vehicle frame, and a drive wheel with driving and steering functions is arranged on a second side of the vehicle frame and adjacent to a rear of the vehicle frame;
each of the two load-bearing wheels is rotatably arranged on a first rotary support member through a pin and a wheel frame, and the first rotary support member is rotatably arranged on the vehicle frame; the vehicle frame is provided with a first steering motor configured to drive each of the two load-bearing wheels to rotate, and a main shaft of the first steering motor is connected to an input end of a first reduction gearbox; the first reduction gearbox is mounted on the vehicle frame through a mounting plate, and an output end of the first reduction gearbox is provided with a tapered pinion; the tapered pinion is engaged with a tapered rack wheel on the first rotary support member, and the tapered rack wheel is integrated with an outer ring of the first rotary support member; and
the drive wheel is arranged on an output end of a second reduction gearbox, and an input end of the second reduction gearbox is provided with a drive motor for driving the drive wheel to rotate; the second reduction gearbox is connected to a second rotary support member, and the second rotary support member is rotatably arranged on a fixed plate on the vehicle frame; the fixed plate is provided with a second steering motor configured to drive the drive wheel to rotate, a main shaft of the second steering motor is provided with a steering pinion, and the steering pinion is engaged with a steering rack wheel on the second rotary support member.

2. The multidirectional driving industrial handling vehicle according to claim 1, wherein one drive wheel is arranged on a rear axis of the vehicle frame, and forms a three-fulcrum structure with the two load-bearing wheels in the front of the vehicle frame.

3. The multidirectional driving industrial handling vehicle according to claim 1, wherein two drive wheels are symmetrically arranged about a rear axis of the vehicle frame, and form a four-fulcrum structure with the two load-bearing wheels in the front of the vehicle frame.

4. The multidirectional driving industrial handling vehicle according to claim 2, further comprising a mast liftably arranged on the vehicle frame, wherein the mast is connected to a lifting cylinder on the vehicle frame, the lifting cylinder is communicated with a hydraulic assembly on the vehicle frame, and a lower end of the mast is connected to a fork frame.

5. The multidirectional driving industrial handling vehicle according to claim 4, wherein a lithium battery is arranged inside the vehicle frame for supplying power to the multidirectional driving industrial handling vehicle.

6. The multidirectional driving industrial handling vehicle according to claim 3, further comprising a mast liftably arranged on the vehicle frame, wherein the mast is connected to a lifting cylinder on the vehicle frame, the lifting cylinder is communicated with a hydraulic assembly on the vehicle frame, and a lower end of the mast is connected to a fork frame.

7. The multidirectional driving industrial handling vehicle according to claim 6, wherein a lithium battery is arranged inside the vehicle frame for supplying power to the multidirectional driving industrial handling vehicle.
